(19) United States
(12) Patent Application Publication
(10) Pub. No.: US 2003/0229411 A1
(43) Pub. Date: Dec. 11, 2003

(54) Method for recipe format parsing

(76) Inventor: You-Wei Shen, Taipei (TW)

Correspondence Address: BIRCH STEWART KOLASCH & BIRCH, PO BOX 747, FALLS CHURCH, VA, 22040-0747, US

(21) Appl. No.: 10/265,272

(22) Filed: Oct. 7, 2002

(30) Foreign Application Priority Data
Jun. 6, 2002 (TW) 91112233

(51) Int. Cl. G06F 19/00

(52) U.S. Cl. 700/121

(57) ABSTRACT

A method for recipe format parsing. The method comprises the steps of providing a recipe format having a first, second and third level respectively with a first tag, a plurality of second tags and recipe data, the first tag linked to one of the second tags and the second tags linked to the corresponding recipe data, reading the first tag of the first level, reading the second tag to which the first tag is linked, and reading the corresponding recipe data to which the read second tag is linked.

### BACKGROUND OF THE INVENTION

1. Field of the Invention

The present invention relates to a method for recipe format parsing and particularly to a dynamic hierarchical recipe parsing rule which is adapted to different recipe formats for equipment.

2. Description of the Prior Art

Integrated circuits are manufactured using silicon wafers by many complicated processes. The wafers are processed by lots. Wafers in the same lot are processed by one process step at the same time. When the process is completed, the wafers are tested for qualification. Finally, the individual integrated circuit is cut from the wafer and then packaged.

In general, Each of the process steps is implemented with one processing station controlled by recipes. For example, the recipes can be temperatures, gas pressures and gas flow. Since there are many process steps implemented by different equipment using different recipes, a recipe database is needed to complete a manufacturing process.

These recipes are stored in the database using a predetermined format. The following shows a recipe format for AMAT Endura CL 300 mm.

| Offset | Title | Length | Description | |
|---|---|---|---|---|
| 0 | TAG_SPARE1 | 1B | unused | |
| 1 | TAG_SPARE2 | 1B | unused | |
| 2 | TAG_SPARE3 | 1B | unused | |
| 3 | RECIPE_TAG | 1B | The types of recipe records | |
| | | | Type | Value |
| | | | RECIPE_HEADER | 0 |
| | | | RECIPE_STEP | 1 |
| | | | RECIPE_STRIP_STEP | 2 |
| | | | RECIPE_FILL | 3 |
| | | | RECIPE_PVD_STEP | 4 |
| | | | RECIPE_MAC_STEP | 5 |
| | | | RECIPE_STEP_EXTENSION | 6 |
| | | | RECIPE_CVD_STEP | 7 |
| | | | RECIPE_HEADER_EXTENSION | 8 |
| 4 | header_detail | 252B | recipe header records | |
| | | | (RECIPE_TAG=0) | |
| 4 | step_detail | 252B | recipe process step records | |
| | | | (RECIPE_TAG=1) | |
| 4 | strip_detail | 252B | recipe process step records for | |
| | | | strip (RECIPE_TAG=2) | |
| 4 | fill_detail | 252B | empty space fill records | |
| | | | (RECIPE_TAG=3) | |
| 4 | pvd_detail | 252B | recipe process step records for | |
| | | | PVD (RECIPE_TAG=4) | |
| 4 | mac_detail | 252B | recipe process step records for | |
| | | | MAC (RECIPE_TAG=5) | |
| 4 | extend_detail | 252B | recipe process step records for | |
| | | | step extension (RECIPE_TAG=6) | |
| 4 | cvd_detail | 252B | recipe process step records for | |
| | | | CVD (RECIPE_TAG=7) | |
| 4 | header_extend_detail | 252B | header for an extension step | |
| | | | (RECIPE_TAG=8) | |

In the table, the offset 3 represents one of the types of the recipes. For example, when the recipe tag is 4, the offset 4 represents recipe process step records for PVD.

However, the conventional recipe format of AMAT Endura CL 300 mm is different and not compatible with the parsing rule for 200 mm equipment. Therefore, a new recipe format must be provided for the Recipe Management System (RMS) to store the recipe data into the database.

### SUMMARY OF THE INVENTION

The object of the present invention is to provide a new recipe format parsed by a dynamic hierarchical recipe parsing rule in order to translate more widely equipment recipe formats into one standard internal-use recipe format and vice versa.

The present invention provides a method for recipe format parsing. The method comprises the steps of providing a recipe format having a first, second and third level respectively with a first tag, a plurality of second tags and recipe data, the first tag linked to one of the second tags and the second tags linked to the corresponding recipe data, reading the first tag of the first level, reading the second tag to which the first tag is linked, and reading the corresponding recipe data to which the read second tag is linked.

The length of the first tag is one byte. The length of one of the second tags is one byte. There are three bytes remain unused in the first level. The second level has 9 second tags. The recipe data of the third level comprises recipe header records, recipe process step records, recipe process step records for strip, empty space fill records, recipe process step records for PVD, recipe process step records for CVD, recipe process step records for MAC, recipe process step records for step extension and header for an extension step. The length of the recipe data is 252 bytes.

Thus, in the present invention, a dynamic hierarchical recipe parsing rule is provided. A self-describing recipe format parsing is accomplished while the RMS is kept unchanged. This translates more widely equipment recipe formats into one standard internal-use recipe format.

### BRIEF DESCRIPTION OF THE DRAWINGS

The present invention will become more fully understood from the detailed description given hereinbelow and the accompanying drawings, given by way of illustration only and thus not intended to be limitative of the present invention.

FIG. 1 shows a hierarchical structure format according to one embodiment of the invention.

FIG. 2 is a flowchart of a method for recipe format parsing according to one embodiment of the invention.

### DETAILED DESCRIPTION OF THE INVENTION

In the following embodiment, a new recipe format is provided. It can be parsed using a dynamic hierarchical recipe parsing rule. A self-describing recipe format parsing is accomplished while the RMS is kept unchanged. This translates wide-ranging equipment recipe formats into one standard internal-use recipe format.

There are three types of recipe format scheme, the first type being the binary recipe parsing scheme, the second type the formatted recipe parsing scheme and the last the text recipe parsing scheme. AMAT Endura CL uses the binary recipe format. As a result, the recipe format of this embodiment shown in the following table is the binary recipe format.

| | | Next | | Next Level |
|---|---|---|---|---|
| Tiltle | Length | Level | Next Level Name | Reference |
| TAG_SPARE1 | 1B | | | |
| TAG_SPARE2 | 1B | | | |
| TAG_SPARE3 | 1B | | | |
| RECIPE_TAG | 1B | IT | RECIPE_TAG | |
| RECIPE_TAG | 1B | T | Header_detail | 0 |
| RECIPE_TAG | 1B | T | Step_detail | 1 |
| RECIPE_TAG | 1B | T | Strip_detail | 2 |
| RECIPE_TAG | 1B | T | Fill_detail | 3 |
| RECIPE_TAG | 1B | T | Pvd_detail | 4 |
| RECIPE_TAG | 1B | T | Mac_detail | 5 |
| RECIPE_TAG | 1B | T | Extend_detail | 6 |
| RECIPE_TAG | 1B | T | Cvd_detail | 7 |
| RECIPE_TAG | 1B | T | Header_extend_detail | 8 |
| Head_Variations | 4B | N | | |
| Head_Record_Length | 4B | N | | |
| Head_Non_Extended_Step_Count | 4B | N | | |
| Head_Recipe_Chamber | 4B | N | | |
| Head_Recipe_Name | 4B | N | | |

It is noted that intermediate tag IT and tag T are added to the conventional recipe format.

The intermediate tag IT describes a value indicating which single structure describes the next recipe content. In this embodiment, the intermediate tag IT is respected with the recipe value on offset 3, the value of recipe indicating which structure is in the next 252 bytes, and how to explain the content of the recipe. The 9 structures are: recipe header records, recipe process step records, recipe process step records for strip, empty space fill records, recipe process step records for PVD, recipe process step records for CVD, recipe process step records for MAC, recipe process step records for step extension and header for an extension step.

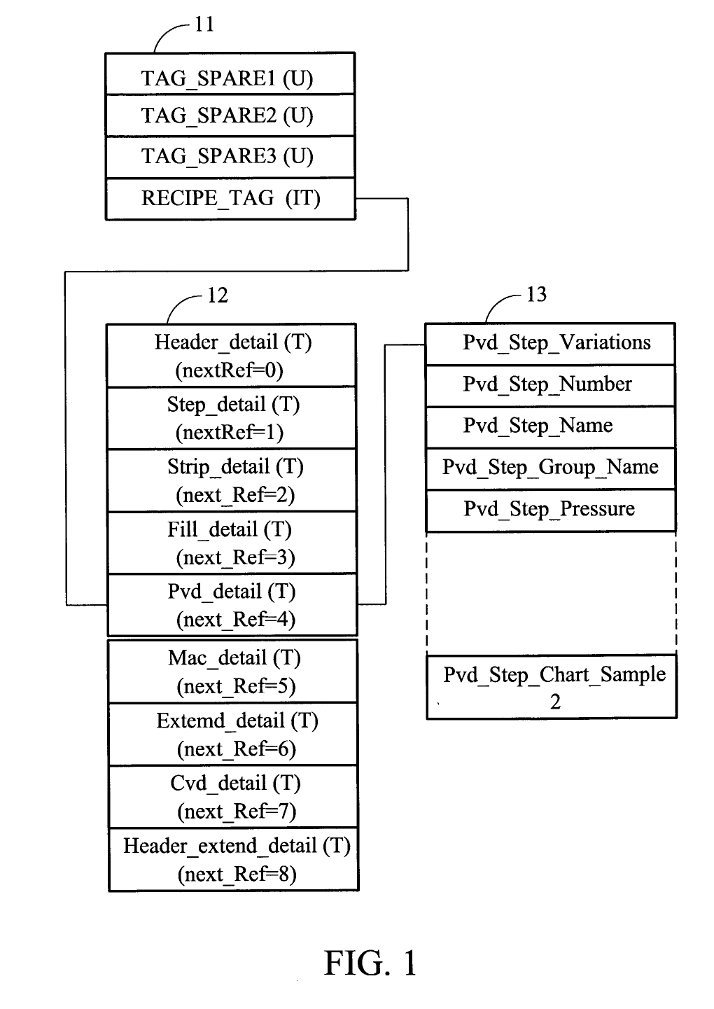

FIG. 1 shows a hierarchical structure format according to one embodiment of the invention. This format includes three levels. The first level is for recipe files 11, the second level is for recipe tags 12 and the third level is for recipe data 13. The first level has four bytes which are TAG_SPARE1, TAG_SPARE2, TAG_SPARE3 and RECIPE_TAG. TAG_SPARE1, TAG_SPARE2, TAG_SPARE3 are three unused bytes. The second level comprises the 9 recipe types. The recipe data is stored in the third level.

First, on the 4^{th} row of the scheme, we set offset=3, next level=IT, next level name=Recipe_Tag and data type=U(Unsigned Char). It represents the structure whose level name is Recipe_Tag, and the value (an unsigned char) to find out which structure is Recipe_Tag. The structure whose level name is Recipe_Tag contains 9 entries in this structure (5^{th} to 13^{th} rows)

Second, there are 9 entries in this structure (5^{th} to 13^{th} rows) whose level name is Recipe₁₃ Tag. Then, next level=T, next level name=Header_detail, the next reference=0 and the datatype=U (one byte, unsigned character) are all set. For example, if the recipe value stored in the offset 3 is 4, the next 252 bytes are the Pvd_detail structure.

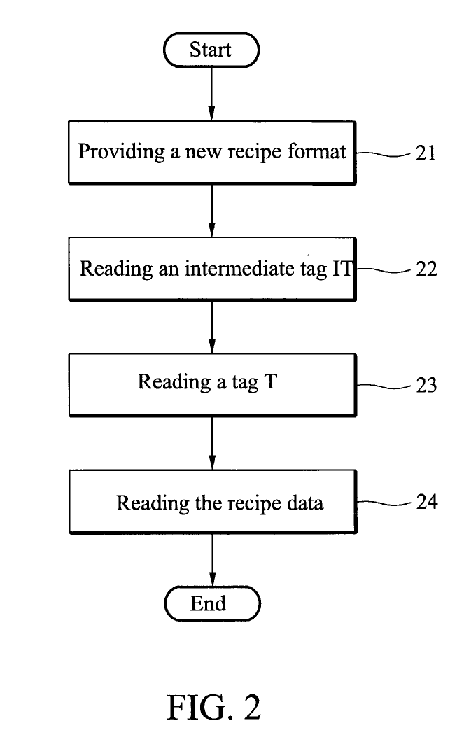

FIG. 2 is a flowchart of a method for recipe format parsing according to one embodiment of the invention.

In step 21, a new recipe format is provided. The new recipe format has a first, second and third level respectively with an intermediate tag(IT), a plurality of tags(T) and recipe data. The intermediate tag IT is linked one of the tags T and the tags T are linked to the corresponding recipe data.

In step 22, the intermediate tag of the first level is read.

In step 23, the tag T to which the intermediate tag IT is linked is read.

In step 24, the corresponding recipe data to which the read tag T is linked is read.

The length of the intermediate tag IT is one byte. The length of one of the tags T is one byte. Three bytes remain unused in the first level. The second level has 9 tags T. The recipe data of the third level comprises recipe header records, recipe process step records, recipe process step records for strip, empty space fill records, recipe process step records for PVD, recipe process step records for CVD, recipe process step records for MAC, recipe process step records for step extension and header for an extension step. The length of the recipe data is 252 bytes

The foregoing description of the preferred embodiments of this invention has been presented for purposes of illustration and description. Obvious modifications or variations are possible in light of the above teaching. The embodiments were chosen and described to provide the best illustration of the principles of this invention and its practical application to thereby enable those skilled in the art to utilize the invention in various embodiments and with various modifications as are suited to the particular use contemplated. All such modifications and variations are within the scope of the present invention as determined by the appended claims when interpreted in accordance with the breadth to which they are fairly, legally, and equitably entitled.

What is claimed is:

1. A method for recipe format parsing comprising the steps of:
providing a recipe format having a first, second and third level respectively with a first tag, a plurality of second tags and recipe data, the first tag linked to one of the second tags and the second tags linked to the corresponding recipe data;
reading the first tag of the first level;
reading the second tag to which the first tag is linked; and
reading the corresponding recipe data to which the read second tag is linked.

2. The method as claimed in claim 1, wherein a length of the first tag is one byte.

3. The method as claimed in claim 1, wherein a length of one of the second tags is one byte.

4. The method as claimed in claim 1, wherein three bytes remain unused in the first level.

5. The method as claimed in claim 1, wherein the second level has 9 second tags.

6. The method as claimed in claim 1, wherein the recipe data of the third level comprises recipe header records, recipe process step records, recipe process step records for strip, empty space fill records, recipe process step records for PVD, recipe process step records for CVD, recipe process step records for MAC, recipe process step records for step extension and header for an extension step.

7. The method as claimed in claim 1, wherein a length of the recipe data is 252 bytes.
